(19) United States
(12) Patent Application Publication
(10) Pub. No.: US 2013/0105727 A1
(43) Pub. Date: May 2, 2013

(54) HEAT STORAGE COMPOSITION COMPRISING A CATIONIC POLYELECTROLYTE AND CALCIUM CHLORIDE HEXAHYDRATE

(71) Applicants: Ralph Rieger, Ludwigshafen (DE); Tina Schroeder-Grimonpont, Rheinzabern (DE); Evgueni Klimov, Ludwigshafen (DE); Gregor Herth, Trostberg (DE)

(72) Inventors: Ralph Rieger, Ludwigshafen (DE); Tina Schroeder-Grimonpont, Rheinzabern (DE); Evgueni Klimov, Ludwigshafen (DE); Gregor Herth, Trostberg (DE)

(21) Appl. No.: 13/666,389

(22) Filed: Nov. 1, 2012

Related U.S. Application Data
(60) Provisional application No. 61/554,515, filed on Nov. 2, 2011.

(51) Int. Cl. C09K 5/00

(52) U.S. Cl. 252/75; 252/71; 252/74

(57) ABSTRACT

The present invention relates to heat storage compositions comprising
70 to 99% by weight of calcium chloride hexahydrate
1 to 10% by weight of one or more cationic polyelectrolytes and
0 to 20% by weight of one or more further salts,
   based in each case on the heat storage composition, to a process for production thereof, to the use thereof as a latent heat storage material and use of the latter in heat-storing building materials and as a heat storage element for vehicles, walls of transport vessels or other heat storage vessels.

The present invention relates to a heat storage composition comprising a cationic polyelectrolyte and calcium chloride hexahydrate. The present invention also relates to a process for production thereof, to the use thereof as a heat-storing building material and as a heat storage element for vehicles, walls of transport vessels or other heat storage vessels.

In the last few years, building materials comprising latent heat storage materials have been studied as a new material combination. The mode of operation of the latent heat storage materials, often also referred to as PCMs (phase change materials), is based on the enthalpy of conversion which occurs at the solid/liquid phase transition, which means an absorption of energy from or release of energy to the environment. They can thus be used to keep the temperature constant within a fixed temperature range. In many cases, the latent heat storage materials used are paraffins which melt when the phase transition is crossed. The liquid phase generally necessitates stabilization of shape by means, for example, of a shell or a capsule wall.

As an alternative to microencapsulation, U.S. Pat. No. 6,319,599 teaches the production of a heat storage composite by dispersion of a superabsorbent such as polyacrylamide and a latent heat storage material in a matrix. The superabsorbent binds the water of the liquid latent heat storage material and thus keeps it in the matrix. The latent heat storage materials used include both alkanes and inorganic salts such as calcium chloride hexahydrate.

Inorganic salt hydrates likewise have high enthalpies of fusion and hence good heat storage properties. A problem with the salt hydrates is, however, that they melt incongruently. Thus, not enough water of crystallization is released to completely dissolve the salt. As well as a salt-saturated aqueous solution, solid hydrates also form with a lower content of water of crystallization than the salt hydrates used. This, however, generally results in separation of the salt hydrates, the consequence of which is that the reaction is not completely reversible and the heat capacity of the system decreases with each cycle.

In order to prevent such a separation, EP 273 779 teaches the polymerization of mixtures of acrylic acid and a crosslinker in the presence of sodium sulfate decahydrate and water. Acrylamide is also used as a comonomer. The superabsorbent which forms binds the water released and thus prevents separation. Polymers based on acrylic acid form an insoluble precipitate with calcium chloride and therefore do not have any heat storage properties. In addition, U.S. Pat. No. 4,585,843 teaches gel polymerization of a mixture of quaternized aminoethyl acrylates and acrylamide in the presence of sodium sulfate decahydrate to remove the heat of polymerization released. Since maximum removal of heat is desired, 160 g of salt are used for 100 g of polymer. The document mentions, in general terms, a wide variety of different inorganic latent heat storage materials, also including calcium chloride hexahydrate, for heat removal. It has been found, however, that mixtures of sodium sulfate decahydrate with the gel which forms are unstable.

It was therefore an object of the present invention to provide compositions in which there is no separation of incongruently melting inorganic latent heat storage salts. In addition, the composition was to have a low tendency to subcooling.

Accordingly, heat storage compositions have been found, comprising

70 to 99% by weight of calcium chloride hexahydrate
1 to 10% by weight of one or more cationic polyelectrolytes and
0 to 20% by weight of one or more further salts,
based in each case on the heat storage composition.

The application further relates to a process for production thereof, to the use thereof as a latent heat storage material and use of the latter in heat-storing building materials and as a heat storage element for vehicles, walls of transport vessels or other heat storage vessels.

Compounds which can derive from acrylic acid and methacrylic acid are in some cases referred to hereinafter in abbreviated form by insertion of the syllable “(meth)” into the compound derived from acrylic acid.

Pure calcium chloride hexahydrate releases 190 J/g in the course of fusion at its melting point of 30° C. It is obtainable in different purities which can vary significantly according to the various production processes and applications. It is commercially available in different purities, for example 90%, 97% or >99%. Since a higher enthalpy of fusion is associated with increasing purity, salts of higher purity are preferred. But good results can also be achieved even with substances of lower purity.

The calcium chloride hexahydrate is used in accordance with the invention in an amount of 70 to 99% by weight, preferably of 85 to 96% by weight and especially of 90 to 95% by weight, based on the heat storage composition.

The cationic polyelectrolyte is used in accordance with the invention in an amount of 1 to 10% by weight, preferably of 2 to 8% by weight and especially of 3 to 7% by weight, based on the heat storage composition.

A cationic polyelectrolyte is understood to mean copolymers of at least one nonionic water-soluble, optionally N-substituted (meth)acrylamide and at least one cationic ethylenically unsaturated monomer. The cationic polyelectrolytes may be linear or branched. Linear polyelectrolytes form homogeneous, high-viscosity solutions in water.

On contact with water or aqueous systems, crosslinked polyelectrolytes form a hydrogel with swelling and absorption of water, and can absorb several times the weight of the pulverulent copolymer. Hydrogels are understood to mean water-comprising gels based on hydrophilic but crosslinked water-insoluble polymers present in the form of three-dimensional networks.

The cationic polyelectrolyte is obtainable by polymerizing a monomer mixture comprising
a) 5-95 mol %, preferably 5 to 70 mol %, of at least one cationic ethylenically unsaturated monomer and
b) 5-95 mol %, preferably 30 to 95 mol %, of at least one nonionic water-soluble, optionally N-substituted (meth)acrylamide,
   based in each case on the total amount of the monomers.

Preferred cationic polyelectrolytes are obtainable by polymerizing a monomer mixture consisting of
a) 5-95 mol %, preferably 5 to 70 mol %, of at least one cationic ethylenically unsaturated monomer and
b) 5-95 mol %, preferably 30-95 mol %, of at least one nonionic water-soluble, optionally N-substituted (meth)acrylamide,
c) 0 to 1 mol % of one or more ethylenically unsaturated crosslinkers

d) 0 to 3 mol % of one or more hydrophobically modified monomers,

based in each case on the total amount of the monomers.

Cationic monomers a) are understood hereinafter to mean monomers which comprise basic groups and have been quaternized or protonated or are protonatable. The monomers listed hereinafter can be used in uncharged form, as salts of acids or in quaternized form.

Preferred cationic ethylenically unsaturated monomers are selected from esters of α,β-ethylenically unsaturated mono- and dicarboxylic acids with amino alcohols, preferably C₂-C₁₂-amino alcohols, amides of α,β-ethylenically unsaturated mono- and dicarboxylic acids with diamines, and the N—C₁-C₈-monoalkylated or N—C₁-C₈-dialkylated derivatives of the esters or amides, and the respective quaternization products of these aforementioned monomer groups.

Suitable acid components of these esters and amides are, for example, acrylic acid, methacrylic acid, fumaric acid, maleic acid, itaconic acid, crotonic acid, maleic anhydride, monobutyl maleate and mixtures thereof. Preference is given to using acrylic acid, methacrylic acid and mixtures thereof.

Preferred monomers which are cationizable, by protonation or alkylation, are, for example, N-methylaminomethyl(meth)acrylate, N-methylaminoethyl(meth)acrylate, N,N-dimethylaminomethyl(meth)acrylate, N,N-dimethylaminoethyl(meth)acrylate, N,N-diethylaminoethyl(meth)acrylate, N,N-dimethylaminopropyl(meth)acrylate, N,N-diethylaminopropyl(meth)acrylate and N,N-dimethylaminocyclohexyl(meth)acrylate.

In addition, suitable further monomers are N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[2-(diethylamino)ethyl]methacrylamide and mixtures thereof.

The respective counterion arises from the neutralizing agent or alkylating agent selected. Examples include chlorides, sulfates, methosulfates.

Suitable quaternizing agents are, for example, dimethyl sulfate, diethyl sulfate, methyl chloride, ethyl chloride or benzyl chloride.

Suitable nonionic water-soluble, optionally N-substituted (meth)acrylamides (monomers b) may be unsubstituted or N-aliphatically or N-aromatically substituted (meth)acrylamides. Preference is given to using the nonionic water-soluble, optionally N-substituted (meth)acrylamides selected from methacrylamide, acrylamide and N—C₁-C₈-alkyl-substituted (meth)acrylamide, N—C₅-C₇-cycloalkyl-substituted (meth)acrylamide and N-benzyl-substituted (meth)acrylamide.

Examples include acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide and/or N-tert-butylacrylamide. Preference is given to acrylamide, methylacrylamide, N,N-dimethylacrylamide and methacrylamide, particular preference to acrylamide.

An ethylenically unsaturated crosslinker is understood to mean a di- or polyunsaturated monomer (monomer c). Possible di- or polyunsaturated monomers are (meth)acrylates having two, three or four acrylate radicals, such as 1,4-butanediol di(meth)acrylate, 1,3-butylene glycol di(meth)acrylate, diethylene glycol di(meth)acrylate, ethylene glycol di(meth)acrylate, ethoxylated bisphenol A di(meth)acrylate, 1,6-hexanediol di(meth)acrylate, neopentyl glycol di(meth)acrylate, polyethylene glycol di(meth)acrylate, triethylene glycol di(meth)acrylate, tripropylene glycol di(meth)acrylate, tetraethylene glycol di(meth)acrylate, dipentaerythrityl penta(meth)acrylate, pentaerythrityl tetra(meth)acrylate, pentaerythrityl tri(meth)acrylate, trimethylolpropane tri(meth)acrylate, cyclopentadiene di(meth)acrylate and/or tris(2-hydroxyethyl) isocyanurate tri(meth)acrylate, monomers having more than one vinyl ester or allyl ester group with corresponding carboxylic acids, such as divinyl esters of polycarboxylic acids, diallyl esters of polycarboxylic acids, triallyl terephthalate, diallyl maleate, diallyl fumarate, trivinyl trimellitate, divinyl adipate and/or diallyl succinate; monomers having more than one (meth)acrylamido group, such as N,N′-methylenebis(meth)acrylamide, and monomers having more than one maleimide group, such as hexamethylenebismaleinimide; monomers having more than one vinyl ether group, such as ethylene glycol divinyl ether, triethylene glycol divinyl ether and/or cyclohexanediol divinyl ether. It is also possible to use allylamino or allylammonium compounds having more than one allyl group, such as triallylamine and/or tetraallylammonium salts.

From the group of the monomers having more than one vinyl aromatic group, divinylbenzene is mentioned.

Preferred ethylenically unsaturated crosslinkers are di- or polyunsaturated methacrylates and (meth)acrylamido-functional and allylamino-functional monomers. Especially preferred are crosslinkers which have particularly good hydrolysis stability. Examples of particularly preferred crosslinker monomers are N,N′-methylenebis-acrylamide, N,N′-methylenebismethacrylamide, triallyl isocyanurate, triallylamine and/or tetraallylammonium salts. It is possible for one or more of the crosslinker monomers in each case to be represented in the copolymers. The crosslinking monomers are present from 0.01 to 1 mol %, preferably from 0.05 to 0.7 mol %, based on the total amount of monomers. The person skilled in the art can determine the amount of crosslinker monomers by conducting routine tests in a simple manner. The crosslinking is affected in the course of the copolymerization reaction; in addition, post crosslinking may also follow the copolymerization reaction, as described for superabsorbents in “F. Buchholz, A. Graham, Modern Superabsorber Technology, John Wiley & Sons Inc., 1989, 55-67”.

Hydrophobically modified monomers (monomers d) are understood to mean monomers of the general formula I

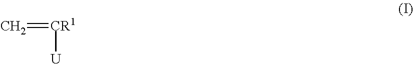

in which

R¹ is hydrogen or methyl

U is —COO(CₘH₂ₘO)ₙ—R² or —(CH₂)ₚ—O(C_{q}H_{2q}O)ᵣ—R³,

m and q are each independently an integer from 2 to 4 (preferably 1 or 2),

n and r are each independently an integer from 1 to 200 (preferably 1 to 20),

p is an integer from 0 to 20 (preferably 1 to 5),

R² and Mare each independently a

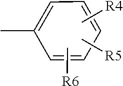

radical where the R⁴, R⁵ and R⁶ radicals are preferably in the para and ortho positions on the aromatic ring, and
R⁴, R⁵ and R⁶ are each independently hydrogen, a C₁-C₆-alkyl group (unbranched or branched, preferably methyl or ethyl group) and/or an arylalkyl group with a C₁-C₁₂-alkyl (unbranched or branched, preferably methyl, ethyl) and a C₆- to C₁₄-aryl radical (preferably 1-phenylethyl).

The R⁴, R⁵ and R⁶ radicals are preferably the same.

Further suitable hydrophobically modified monomers are those of the general formula II:

H₂C═C(R⁷)—R¹⁰—O—(—CH₂—CH(R⁸)—O—)ₖ—(—CH₂—CH(R⁹)—O—)ₗ—H (II),

where the —(—CH₂—CH(R⁸)—O—)ₖ and —(—CH₂—CH(R⁹)—O—)ₗ units are arranged in block structure in sequence shown in formula (II) and the radicals and indices are each defined as follows:
k: a number from 10 to 150,
l: a number from 5 to 25,
R⁷: H or methyl,
R⁸: independently H, methyl or ethyl, with the proviso that at least 50 mol % of the R⁸ radicals are H,
R⁹: independently a hydrocarbyl radical having at least 3 carbon atoms or an ether group of the general formula —CH₂—O—R⁹′, where R⁹′ is a hydrocarbyl radical having at least 3 carbon atoms,
R¹⁰: a single bond or a divalent linking group selected from the group of —(CₙH₂ₙ)—(R^{10a})—, —O—(C_{n′}H_{2n′})—(R^{10b)— and —C(O)—O—(C}_{n″}H_{2n′})′(R^{10c})—, where n, n′ and n″ are each a natural number from 1 to 6.

Examples of monomers d) include tristyrylphenol polyethylene glycol 1100 methacrylate, tristyrylphenol polyethylene glycol 1100 acrylate, tristyrylphenol polyethylene glycol 1100 monovinyl ether, tristyrylphenol polyethylene glycol 1100 vinyloxybutyl ether and tristyrylphenol polyethylene glycol 1100 block-propylene glycol allyl ether. Tristryrylphenol compounds are understood by those skilled in the art to mean tris(1-phenylethyl)phenol compounds.

Further examples of monomers of the general formula II include: allyl polyethylene glycol (350 to 2000), methyl polyethylene glycol (350-3000) monovinyl ether, polyethylene glycol (500-5000) vinyloxybutyl ether, polyethylene glycol-block-propylene glycol (500 to 5000) vinyloxybutyl ether, methyl polyethylene glycol-block-propylene glycol allyl ether, methyl polyethylene glycol 750 methycrylate, polyethylene glycol 500 methycrylate, methyl polyethylene glycol 2000 monovinyl ether and/or methyl polyethylene glycol-block-propylene glycol allyl ether.

The cationic polyelectrolytes comprise generally at least 5 mol %, preferably at least 7 mol %, and generally at most 95 mol %, preferably at most 70 mol % and more preferably at most 50 mol %, of at least one cationic ethylenically unsaturated monomer in polymerized form, based on the total amount of the monomers.

According to the invention, the cationic polyelectrolytes comprise generally at least 5 mol %, preferably at least 30 mol %, more preferably at least 50 mol %, and generally at most 95 mol %, preferably at most 93 mol %, of one or more nonionic water-soluble ethylenically unsaturated monomers in polymerized form, based on the total amount of the monomers.

In addition, the cationic polyelectrolytes may comprise up to 1 mol %, preferably up to 0.8 mol %, especially up to 0.5 mol % and more preferably to 0.4 mol % of one or more crosslinkers in polymerized form, based on the total amount of the monomers. If they comprise one or more crosslinkers in polymerized form, the proportion is preferably at least 0.01 mol %, based on the total amount of the monomers.

In addition, the cationic polyelectrolytes may comprise up to 3 mol %, preferably up to 2 mol %, especially up to 1.5 mol % and more preferably up to 0.4 mol % of one or more monoethylenically unsaturated hydrophobic monomers other than the monomers a) in polymerized form, based on the total amount of the monomers. If they comprise one or more ethylenically unsaturated hydrophobic monomers in polymerized form, the proportion is preferably at least 0.01 mol %, based on the total amount of the monomers.

In a preferred embodiment, preference is given to cationic polyelectrolytes which have been crosslinked. More particularly, cationic polyelectrolytes are obtainable by polymerizing a monomer mixture comprising
a) 5 to 7 mol % of at least one cationic ethylenically unsaturated monomer and
b) 30 to 95 mol % of at least one nonionic water-soluble, optionally N-substituted (meth)acrylamide,
c) 0.01 to 1.0 mol % of one or more crosslinkers, based in each case on the total amount of monomers.

In a further preferred embodiment, preference is given to cationic polyelectrolytes which have been crosslinked or are uncrosslinked and comprise a hydrophobically modified monomer in polymerized form. More particularly, cationic polyelectrolytes are obtainable by polymerizing a monomer mixture comprising
a) 5 to 70 mol % of at least one cationic ethylenically unsaturated monomer and
b) 30 to 95 mol % of at least one nonionic water-soluble, optionally N-substituted (meth)acrylamide,
c) 0.001 to 1.0 mol % of one or more hydrophobically modified monomers,
   based in each case on the total amount of monomers.

The cationic polyelectrolytes are prepared in a manner known per se by free-radical polymerization of the monomers. The monomers are copolymerized by free-radical bulk, solution, gel, emulsion, dispersion or suspension polymerization. Processes for preparing cationic, hydrophobically modified polyelectrolytes are known and are described, for example, in DE 10 2006050761, to which reference is made explicitly. The teaching given therein can be applied to the preparation of the cationic polyelectrolytes.

Since the inventive products are hydrophilic water-swellable copolymers, preference is given to polymerization in the aqueous phase, polymerization in inverse emulsion, or polymerization in inverse suspension. In particularly preferred embodiments, the reaction is effected as a gel polymerization or as an inverse suspension polymerization in organic solvents.

In a particularly preferred embodiment, the copolymerization of the cationic polyelectrolyte can be performed as an adiabatic polymerization.

The monomers are (co)polymerized with one another in 20 to 80%, preferably 20 to 50% and especially 30 to 45% by weight aqueous solution in the presence of polymerization initiators. The polymerization initiators used may be all compounds which decompose to free radicals under the polymerization conditions, for example peroxides, hydroperoxides, hydrogen peroxide, persulfates, azo compounds, and what are called the redox initiators and photoinitiators. Such polymerization inhibitors and the preferred use amounts are common knowledge.

Preference is given to the use of water-soluble initiators. In some cases, it is advantageous to use mixtures of different polymerization initiators, for example mixtures of hydrogen peroxide and sodium peroxodisulfate or potassium peroxodisulfate. Mixtures of hydrogen peroxide and sodium peroxodisulfate can be used in any desired ratio. Preference is given to redox initiators comprising an oxidizing component, for example a per compound, and a reducing component such as ascorbic acid. Preference is given to using a redox initiator consisting of hydrogen peroxide, sodium peroxodisulfate and ascorbic acid. The proportion by weight of the oxidizing and reducing components in the case of the redox initiator systems is in each case in the range from 0.00005 to 0.5% by weight, preferably in each case between 0.001 and 0.1% by weight, based on the total amount of the monomers.

In the case of a photopolymerization, this is commenced with UV light which causes the decomposition of a photoinitiator. The photoinitiators used may, for example, be benzoin and benzoin derivatives, such as benzoin ether, benzil and derivatives thereof, such as benzil ketals, aryldiazonium salts, azo initiators, for example 2,2′-azobis(isobutyronitrile), 2,2′-azobis(2-amidinopropane) hydrochloride, and/or acetophenone derivatives. For photoinitiators, the amount used is in the range from 0.001 to 0.1% by weight, preferably 0.002 to 0.05% by weight, based on the total amount of the monomers.

In addition, a combination of the two initiation variants is possible, i.e. the use of redox initiators and photoinitiators.

The aqueous monomer solution can be added to the initiator in dissolved or dispersed form. The initiators can, however, also be supplied to the polymerization reactor separately from the monomer solution. The polymerization conditions, more particularly the amounts of initiator, are selected with the aim of obtaining very long-chain polymers. Due to the insolubility of the crosslinked copolymers and the length of the polymer chains, the molecular weights, however, are amenable to measurement only with very great difficulty.

The polymerization is performed in aqueous solution, preferably in concentrated aqueous solution, batchwise in a polymerization vessel (batchwise process) or continuously by the “continuous belt” method described in U.S. Pat. No. 4,857,610. A further option is polymerization in a kneading reactor operated continuously or batchwise. The process is initiated at a temperature between −20 and 20° C., preferably between −10 and 10° C., and is performed at atmospheric pressure without external supply of heat, the heat of polymerization resulting in a maximum final temperature, dependent on the monomer content, of 50 to 150° C. The end of the copolymerization is followed by a comminution of the polymer present in gel form. In the case of performance on the laboratory scale, the comminuted gel is dried in a forced air drying cabinet at 70 to 180° C., preferably at 80 to 150° C. On the industrial scale, the drying can also be effected in a continuous manner in the same temperature ranges, for example on a belt drier or in a fluidized bed drier.

In a further preferred embodiment, the copolymerization is effected as an inverse suspension polymerization of the aqueous monomer phase in an organic solvent, as described in DE102007027470, the disclosure of which is referred to explicitly.

In addition, further salts can be added to the inventive heat storage composition. The salts suitable in accordance with the invention influence the temperature of the phase transition.

The melting point of pure calcium chloride hexahydrate is 30° C., which need not necessarily correspond to the desired switching temperature in the application. Therefore, it is possible in accordance with the invention to add up to 20% by weight of another organic or inorganic salt other than calcium chloride hexahydrate, in order to lower the melting point of the heat storage composition.

The salt is preferably selected from the alkali metal, alkaline earth metal, ammonium and choline halides, and alkali metal, alkaline earth metal, ammonium and choline acetates, soluble in calcium chloride hexahydrate. Examples include sodium chloride, potassium chloride, ammonium chloride, choline chloride, magnesium chloride, calcium chloride, strontium chloride, barium chloride, sodium bromide, potassium bromide, ammonium bromide, choline bromide, magnesium bromide, calcium bromide, strontium bromide, barium bromide, sodium acetate, potassium acetate, ammonium acetate, choline acetate, magnesium acetate and calcium acetate. Preference is given to sodium chloride, potassium chloride and/or ammonium chloride.

These further salts are used in accordance with the invention in an amount up to 20% by weight, preferably of 2 to 10% by weight, based on the heat storage composition. In general, the amount used is determined by the desired lowering of the melting temperature.

If the salts are insoluble in the molten calcium chloride hexahydrate, they can also act as nucleators.

Nucleators, also referred to as nucleating agents, are understood to mean substances which, in the presence of molten calcium chloride hexahydrate, generate or act as crystallization seeds (Römpp Chemie Lexikon, Thieme Verlag) which promote the formation of a larger number of smaller crystals and accelerate the crystallization process. In this way, subcooling of the melt can be reduced.

A wide variety of different further salts can act as nucleators, for example borax (disodium tetraborate decahydrate), titanium dioxide, Al₂O₃ (aluminum oxide), ZnO (zinc oxide), Zn(OH)₂ (zinc hydroxide), barium sulfate (BaSO₄), strontium sulfate (SrSO₄), alkaline earth metal halides and silicon dioxide. Further nucleators which can be added are copper powder or graphite. The nucleator is preferably selected from the alkaline earth metal halides. Particular preference is given to barium chloride and strontium chloride.

The nucleator is used preferably in an amount of 0.1 to 10% by weight, more preferably of 1 to 5% by weight, based on the overall composition.

It is additionally possible to add up to 30% by weight, based on the heat storage composition, of water. The addition of such small amounts of water does not have any adverse effect on the stability of the calcium chloride hexahydrate. The addition leads merely to a slight decrease in the heat capacity of the composition.

The heat storage composition preferably comprises

85 to 96% by weight of calcium chloride hexahydrate
2 to 8% by weight of one or more cationic polyelectrolytes and
2 to 10% by weight of one or more further salts,
based in each case on the heat storage composition.

The heat storage compositions should preferably be homogeneous. The simplest route in the production of the heat storage composition is therefore via the melt. The inventive heat storage composition is produced, for example, by producing a mixture comprising calcium chloride hexahydrate and cationic polyelectrolyte, and optionally one or more further salts in the inventive composition, and then melting it. The mixture preferably consists exclusively of calcium chloride hexahydrate, cationic polyelectrolyte and one or more further salts in the inventive composition.

The inventive heat storage composition is preferably produced by heating the composition constituents comprising

70 to 99% by weight of calcium chloride hexahydrate
1 to 10% by weight of one or more cationic polyelectrolytes and
up to 20% by weight of one or more further salts, preferably 0 to 10% by weight, preferably in solid form, and heating them to >25° C. In this embodiment, it is essential that the cationic polyelectrolyte is used as one component of the mixture. The mixture preferably consists exclusively of calcium chloride hexahydrate, cationic polyelectrolyte, and optionally further salts in the inventive composition.

In the course of production of the heat storage composition, a homogeneous mixture of all composition constituents is advantageous. Since the composition constituents are all in solid form at room temperature, the sequence of addition is as desired. A homogeneous distribution of the mixture constituents can be achieved with a stirrer or kneader. It is advantageous that cationic polyelectrolyte and salt hydrate are heated already in the form of a mixture.

Preference is given to heating the composition to a temperature of 25 to 65° C. Even from a temperature of 25° C., softening is observed. It is advantageous, however, to heat to a temperature at least 20° C. above the melting point of calcium chloride hexahydrate or of the temperature-lowered mixture. A temperature above 60° C. is generally not advantageous since water vapor forms. Preference is given to heating to a temperature in the range from 30 to 50° C. It is advantageous in accordance with the invention to stir during melting. This can be done, for example, in a kneader. Subsequently, the mixture is allowed to cool to room temperature.

In a preferred variant, the inventive composition is surrounded by a water vapor-tight shell. The material for such a shell may be either flexible or rigid. A rigid embodiment corresponds to a water vapor-tight vessel or container. “Water vapor-tight” is understood to mean that, over a period of 30 days at a temperature of 25° C., the water content falls as a result of evaporation by less than 5%, preferably by less than 1%. Suitable shell materials are, for example, polyethylene, metals such as aluminum, or laminates composed of polyethylene and metals. The shell material is preferably used in the form of a film. Preference is given to selecting a flexible casing, preferably a multicell laminate film as described in U.S. Pat. No. 5,626,936, in order to ensure that, in the event of damage to the film, the material continues to function in the remaining undamaged cells.

The inventive heat storage compositions can be used advantageously as latent heat stores. Inventive compositions encased in such a way can be used as heat-storing building material in home construction, industrial construction, refrigerated warehouse construction, in sectional doors, in office containers, or in automobile construction, caravan construction and shipbuilding, and also in walls for lightweight constructions. This makes it possible to prevent both excessive heating and, in the event of falling outside temperatures, cooling.

For this purpose, for example, an above-described laminate film can be mounted in cavities, as in encountered in roof linings, in dry construction, under roof insulation or behind wall panels. Also conceivable is incorporation into pieces of furniture, for example mounting on the back walls of cabinets or under tabletops.

In addition, they can be used in the walls of transport vessels for cooling or other heat storage vessels. The heat storage compositions are also suitable for heat tanks. This is understood to mean a large vessel which is filled with the heat storage composition and has a heat exchanger, such that it is possible to pump, for example, a heat carrier fluid, typically water, in circulation into a central heating system in order to convey the heat from the tank into the rooms whose temperature is to be controlled or, conversely, excess heat from the rooms into the central heat tank. Likewise possible is a mobile application, by virtue of the tank being mounted on a truck, such that, for example, excess heat can be transported from power plants to any use sites and can be released there to an above-described pumped circulation system.

The examples which follow are intended to illustrate the invention in detail. The percentages in the examples are percent by weight, unless stated otherwise.

### DSC Analysis:

A sample was analyzed by means of differential calorimetry analysis for the melting point and enthalpy of fusion (instrument: DSC Q2000 from TA Instruments). To this end, a sample of 5 mg was introduced into a closed sample pan and heated at 1 K/min to 50° C., then cooled to −30° C. and heated again to 50° C. The enthalpy of fusion was inferred from the area below the heat flow-temperature curve in the second heating run.

### Polyelectrolyte 4 (P4) (Linear)

A 2 l three-neck flask with stirrer and thermometer was initially charged with 296 g of water. Subsequently, 329 g of a 60% by weight of aqueous solution of 3-(acryloylamino)propyl]trimethylammonium chloride (DIMAPA quat) (0.95 mol, 27 mol %) and 355 g of a 50% by weight aqueous solution of acrylamide (2.6 mol, 73 mol %) were added. As a molecular weight regulator, 50 ppm of formic acid were added. The solution was adjusted to pH=7 with 20% sodium hydroxide solution, inertized by purging with nitrogen for 30 minutes and cooled to approx. 5° C. The solution was transferred to a plastic cup with the dimensions (w*d*h) of 15 cm*10 cm*20 cm, and then the following added successively: 150 mg of 2,2′-azobis(2-amidinopropane) dihydrochloride, 1.0 g of 1% Rongalit C solution and 10 g of 0.1% tert-butyl hydroperoxide solution. The polymerization was initiated by irradiating with UV light (two Philips tubes; Cleo Performance 40 W). After approx. 2 h, the hard gel was removed from the plastic vessel and cut with scissors into gel cubes of approx. 5 cm*5 cm*5 cm in size. Before the gel cubes were comminuted by means of a conventional meat grinder, they were painted with the separating agent Sitren 595 (polydimethylsiloxane emulsion; from Goldschmidt). The separating agent was a polydimethylsiloxane emulsion which had been diluted 1:20 with water.

The resulting gel granules of polyelectrolyte 1 were distributed homogeneously on drying grids and dried to constant weight in a forced air drying cabinet at approx. 90-120° C. under reduced pressure.

This gave approx. 375 g of hard white granules, which were converted to a pulverulent state with the aid of a centrifugal mill.

Polyelectrolyte 5 (P5) (Linear with Hydrophobic Side Chain)

A 2 l three-neck flask with stirrer and thermometer was initially charged with 296 g of water. Subsequently, the following were added successively: 319 g of a 60% by weight aqueous solution of [3-(acryloylamino)propyl]trimethylammonium chloride (DIMAPA quat) (0.92 mol, 26.8 mol %), 355 g of a 50% by weight aqueous solution of acrylamide (2.5 mol, 73 mol %) and 19 g of Sipomer SEM 25 (from Rhodia, 60% by weight aqueous solution of tristyrylphenol polyethylene glycol 1100 methacrylate) (0.0068 mol, 0.2 mol %). As a molecular weight regulator, 50 ppm of formic acid were added. The solution was adjusted to pH=7 with 20% sodium hydroxide solution and the further procedure was as described for polyelectrolyte 1.

Approx. 375 g of hard white granules were obtained, which were converted to a pulverulent state with the aid of a centrifugal mill.

Polyelectrolyte 6 (P6) (crosslinked copolymer) A 2 l three-neck flask with stirrer and thermometer was initially charged with 345.6 g of water. Subsequently, the following were added successively: 308.60 g of a 60% by weight aqueous solution of [3-(acryloylamino)propyl]trimethylammonium chloride (DIMAPA quat) (0.90 mol, 27 mol %), 328.25 g of a 50% by weight aqueous solution of acrylamide (2.30 mol, 73 mol %) and 0.4 g (0.0028 mol, 0.08 mol %) of methylenebisacrylamide (MbA). The solution was adjusted to pH=7 with 20% sodium hydroxide solution, and the further procedure was as described for polyelectrolyte 1.

Approx. 280 g of hard white granules were obtained, which were converted to a pulverulent state with the aid of a centrifugal mill.

Analogously to the production of polyelectrolyte according to examples P4 to P6, further polyelectrolytes P1 to P3 and P7 to P10 were produced, which differed in terms of their monomer composition and which can be found in table 1 below.

TABLE 1
Polyelectrolytes

| | | | | Hydrophobic |
|---|---|---|---|---|
| | Cat. Monomer | Acrylamide | Crosslinker | monomer |
| Example | [mol %] | [mol %] | [mol %] | [mol %] |
| P1 n.i. | — | 100 | — | — |
| P2 n.i. | — | 99.8 | — | 0.2 SEM 25 |
| P3 n.i. | — | 99.9 | 0.08 MbA | — |
| P4 | 27% DIMAPA quat | 73 | — | — |
| P5 | 27% DIMAPA quat | 73 | — | 0.2 SEM 25 |
| P6 | 27% DIMAPA quat | 72.9 | 0.08 MbA | — |
| P 7 | 42% Madame quat | 68 | | |
| P 8 | 42% Madame quat | 67.8 | | 0.2 SEM 25 |
| P 9 | 42% DIMAPA quat | 67.8 | | 0.2 SEM 25 |
| P 10 | 58% DIMAPA quat | 42 | | |

Abbreviations:
DIMAPA quat = [3-(acryloylamino)propyl]trimethylammonium chloride
Madame quat = [2-(methacryloyloxo)ethyl]trimethylammonium chloride
SEM 25 = tristyryiphenol polyethylene glycol 1100 methacrylate
MbA = methylenebisacrylamide
n.i.: not inventive

### EXAMPLE 1

### Production of the Heat Storage Composition

### Composition:

9.3 g of calcium chloride hexahydrate
0.4 g of polyelectrolyte P1
0.3 g of strontium chloride dihydrate

The above ingredients were mixed as a powder and heated in a plastic cup with a lid to 65° C. for one hour. The resulting material was cooled until solidification and ground to small particles.

### EXAMPLES 2-10

Analogously to example 1, polyelectrolytes P2 to P10 were used to produce further heat storage compositions, and DSC was used to determine the enthalpies of fusion thereof, which can be found in table 2.

| Example | Polyelectrolyte | ΔHₘ (J/g) |
|---|---|---|
| 1 n.i. | P1 | phase separation |
| 2 n.i. | P2 | phase separation |
| 3 n.i. | P3 | phase separation |
| 4 | P4 | 155 |
| 5 | P5 | 145 |
| 6 | P6 | 150 |
| 7 | P7 | 145 |
| 8 | P8 | 155 |
| 9 | P9 | 150 |
| 10 | P10 | 155 |

n.i.: not inventive
phase separation = phase separation in the course of production of the heat storage composition

The composition from example 6 is subjected to an extended cycling test: a 10 ml ampoule is filled to the top with the composition from example 6, then the ampoule is sealed air- and watertight. Then it is immersed into the water bath of a cryostat. The cryostat runs through the following temperature program 1000 times:

heating to 50° C. within 10 minutes
holding the temperature at 50° C. for 10 minutes
cooling to 10° C. within 10 minutes
holding the temperature at 10° C. for 30 minutes

After 1000 cycles, a sample of the composition is subjected to a DSC analysis. A melting point of 30° C. and an enthalpy of fusion of 153 J/g were found.

U.S. Provisional Patent Application No. 61/554,515, filed Nov. 2, 2011, is incorporated into the present application by literature reference.

1. A heat storage composition comprising
70 to 99% by weight of calcium chloride hexahydrate
1 to 10% by weight of one or more cationic polyelectrolytes and
0 to 20% by weight of one or more further salts,
based in each case on the heat storage composition.

2. The heat storage composition according to claim 1, wherein the cationic polyelectrolyte is obtainable by polymerizing a monomer mixture comprising
a) 5-95 mol % of at least one cationic ethylenically unsaturated monomer and
b) 5-95 mol % of at least one nonionic water-soluble, optionally N-substituted (meth)acrylamide,
based in each case on the total amount of the monomers.

3. The heat storage composition according to claim 1 or 2, wherein the cationic polyelectrolyte is obtainable by polymerizing a monomer mixture comprising
a) 5-95 mol % of at least one cationic ethylenically unsaturated monomer and
b) 5-95 mol % of at least one nonionic water-soluble, optionally N-substituted (meth)acrylamide,
c) 0 to 1 mol % of one or more ethylenically unsaturated crosslinkers
d) 0 to 3 mol % of one or more hydrophobically modified monomers,
based in each case on the total amount of the monomers.

4. The heat storage composition according to any of claims 1 to 3, wherein the cationic polyelectrolyte has been crosslinked.

5. The heat storage composition according to any of claims 1 to 4, wherein the polyelectrolyte has been crosslinked or is uncrosslinked and comprises a hydrophobically modified monomer in polymerized form.

6. The heat storage composition according to any of claims 1 to 5, comprising
85 to 96% by weight of calcium chloride hexahydrate
2 to 8% by weight of one or more cationic polyelectrolytes and
2 to 10% by weight of one or more further salts,
based in each case on the heat storage composition.

7. The heat storage composition according to any of claims 1 to 6, wherein the further salt is selected from borax (disodium tetraborate decahydrate), titanium dioxide, Al₂O₃, ZnO, Zn(OH)₂, BaSO₄, alkaline earth metal halides, SrSO₄, copper powder, graphite and silicon dioxide.

8. The heat storage composition according to any of claims 1 to 7, wherein the further salt is selected from alkali metal, alkaline earth metal, ammonium and choline halides, and alkali metal, alkaline earth metal, ammonium and choline acetates.

9. The heat storage composition according to any of claims 1 to 8, obtainable by combining the composition constituents comprising
70 to 99% by weight of calcium chloride hexahydrate
1 to 10% by weight of one or more cationic polyelectrolytes and
0 to 20% by weight of one or more further salts,
and heating them to >25° C.

10. The heat storage composition according to any of claims 1 to 9, which is surrounded by a water vapor-tight shell.

11. A process for producing a heat storage composition according to claims 1 to 10, which comprises combining the composition constituents comprising 70 to 99% by weight of calcium chloride hexahydrate, 1 to 10% by weight of one or more cationic polyelectrolytes and optionally up to 20% by weight of one or more further salts, and heating them to >25° C.

12. The use of the heat storage composition according to claims 1 to 10 as a latent heat store.

13. The use of the heat storage composition according to claims 1 to 10 as a latent heat store in heat-storing building materials.

14. The use of the heat storage composition according to claims 1 to 10 as a heat storage element for vehicles, walls of transport vessels or other heat storage vessels.
